(19) United States
(12) Patent Application Publication
(10) Pub. No.: US 2004/0054763 A1
(43) Pub. Date: Mar. 18, 2004

(54) Method for minimizing connection time for data synchronization

(76) Inventors: Jin Teik Teh, Los Altos, CA (US); Ling Wang, Union City, CA (US)

Correspondence Address: SUPREME PATENT SERVICES, POST OFFICE BOX 2339, SARATOGA, CA, 95070, US

(21) Appl. No.: 10/357,946

(22) Filed: Feb. 3, 2003

Related U.S. Application Data
(60) Provisional application No. 60/410,583, filed on Sep. 12, 2002.

(51) Int. Cl. G06F 15/177

(52) U.S. Cl. 709/221

(57) ABSTRACT

The present invention, a disconnected synchronization protocol, minimizes the time spent connected while synchronizing data between disparate data sets residing on an application server and on one or more clients. The concept of application server and clients are interchangeable. The disconnected synchronization protocol takes the philosophy of connecting, sending changes, and disconnecting. The major work of synchronization, conflict resolution, and identifying additions, removals and updates belongs to the server, and a client is connected to the server only when the actual data exchange takes place, i.e., sending and receiving updates.

### FIELD OF THE INVENTION

This invention relates to a data synchronization method for a data delivery software system, and more particular to a method to minimize client connection time while performing data synchronization with the data delivery software system.

### BACKGROUND OF THE INVENTION

The increasing demand of mobility is a major driving force behind the development of wireless data delivery systems. As wireless devices becoming a business necessity, they rely on a software data delivery system to provide them access to various applications. However, as the most wireless devices are small in size, only a small portion of the data can be stored in the wireless devices, while most of the data, both application specific or device related information, are saved in the application servers. Because of this, the updating of data on either side as requested by the other, called data synchronization, becomes an operation that the system must perform regularly, if not frequently.

However, as device connection time is usually considered as a major cost factor to clients, and a major performance factor on the system, it is preferable to minimize the connection time between the devices and the system while performing the data synchronization operation.

### SUMMARY OF THE INVENTION

The present invention, a disconnected synchronization protocol, minimizes the time spent connected while synchronizing data between disparate data sets residing on an application server and on one or more clients. The concept of application server and clients are interchangeable. The disconnected synchronization protocol takes the philosophy of connecting, sending changes, and disconnecting. The major work of synchronization, conflict resolution, and identifying additions, removals and updates belongs to the server.

The platform server of the system, which sits between the server and client, has the responsibility of maintaining the capabilities of every client device as each client may have different memory limitations. A device application information record (DAIR) table is maintained by the application server to keep track of what records a client device has. This is essential only when the client has only a subset of records that the application server has. This could happen when a client has reached its capacity or when the client has requested one or more categories or subsets from the application server. The present invention, a disconnected synchronization protocol, is a protocol for synchronization, partial synchronization and data retrieval.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1A shows the flowchart of the process at a client when updating a server.

FIG. 1B shows the flowchart of the process at a server when a client updates.

FIG. 2 shows the flowchart of the process at a server when updating a client.

FIG. 3 shows the flowchart of the process at a server when receiving a request for data from a client.

### DETAILED DESCRIPTION OF THE INVENTION

The present invention defines a device application information record (DAIR) table, maintained by an application server to keep track of what records each client device has. A table entry represents a client. The table is consulted and updated when an application server receives data synchronization requests from a client. This is essential when the client has only a subset of records that the application server has. The table has the following fields: a user ID, showing the owner of this client; a registered device ID; an application ID; a module ID, indicating a module within the application, e.g., phone book, calendar, that can be synchronized; a capacity, showing the maximum number of records that a client's application can hold; and the last time a client updates this server and the last time the server update this client. When a client has only a subset of the server's record set, the DAIR table also contains a list of server record Ids, a number of categories, a category criteria, and an exception list.

Whenever the client needs to send updates to the server, including any changes in the client configuration, such as capacity changes due to adding memory, change of passwords, or subscription updates, the client puts together all the changes and sends it to the server. The server accepts the message for processing and returns a result code. The detailed processes taking place at the client and at the server are described in the following figures.

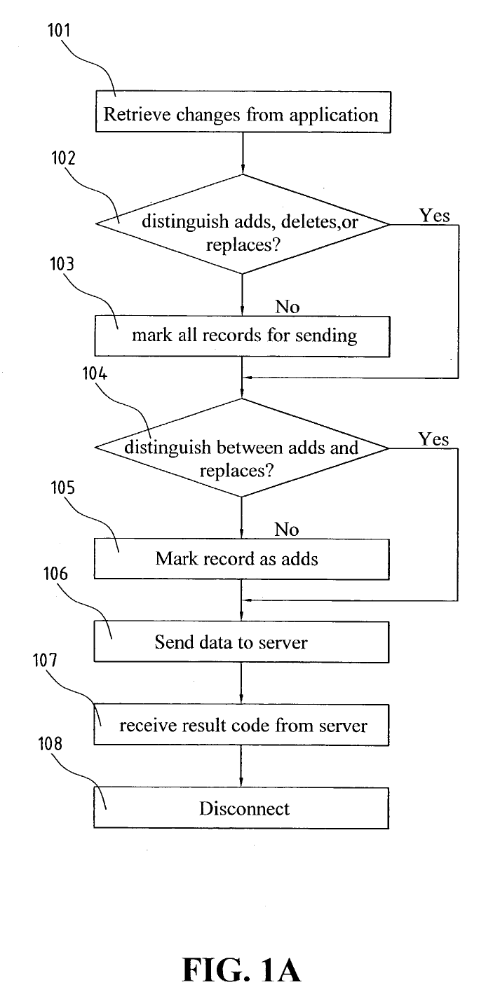

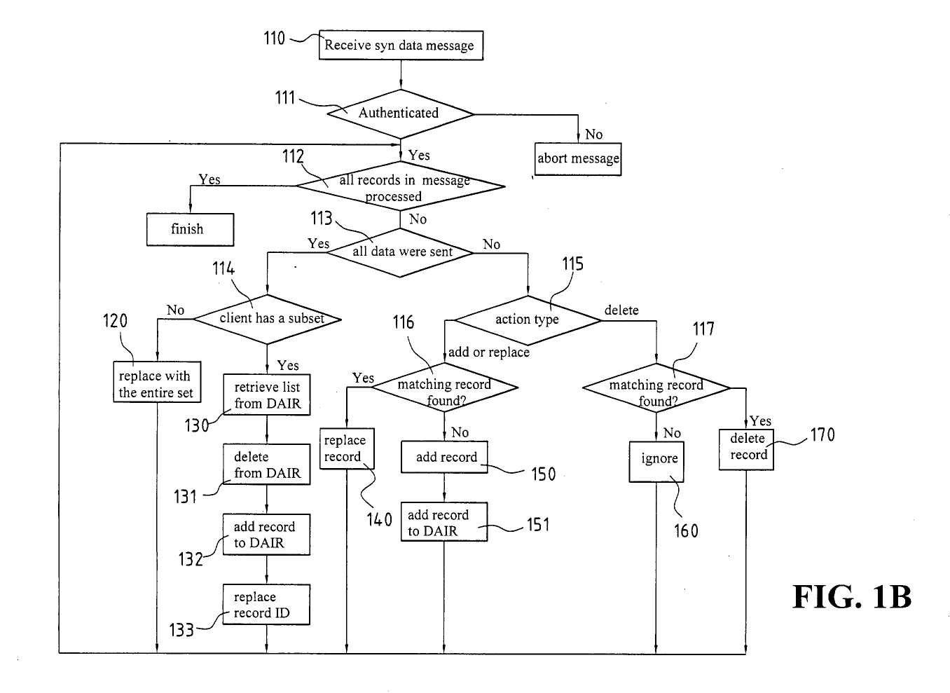

FIG. 1A shows the flowchart of the process taking place at a client when a client wants to update an application server. First, a client must retrieve changes from the application, as shown in step 101. After changes are retrieved, a client must determine if it can distinguish all the changes are adds, deletes, or replaces, as step 102 indicates. If it cannot, it marks all records for sending, as step 103. If it can distinguish deletes from adds and replaces, it must further determine if it can distinguish adds from replaces, as step 104. If not, it simply marks all records as adds, as step 105. At the end of step 105, the data is ready for sending to the server. Step 106, 107 shows the data being sent to the server, and a result code being received from the server. Upon receiving the result code, the client disconnects from the system, shown in step 108.

FIG. 1B shows the process taking place on the application server. Upon receiving the message from the client, the server must determine if the message is authenticated (step 111). If not, the message is aborted. Otherwise, it goes into a loop (step 112) until all the records in the message are processed. Step 113 shows a step to determine if the client has sent all its data. If so, the server must consult the DAIR to determine whether the client has only a subset of the entire data, as step 114. Otherwise, this means that the client is able to distinguish adds, deletes, or replaces, and the data sent by the client are a list of these actions. In this case, step 115 is taken to test on each record for action type. If the result. of the test in step 114 is false, the server simply replaces the entire data set with those in the received message, as shown in step 120. Otherwise, the server takes step 130, 131, 132 and 133 to update the records maintained in the DAIR. On the other hand, if an action is either an add or a replace action (step 115), the server must determine if a matching record can be found (step 116). If a matching record is found, the server takes step 140 to replace the existing record. Otherwise, it takes step 150, 151 to add the record, and update DAIR entry. When an action is of the delete type, and the matching record is found (step 117), the record is deleted, as step 170 shows. Otherwise, the action is ignored.

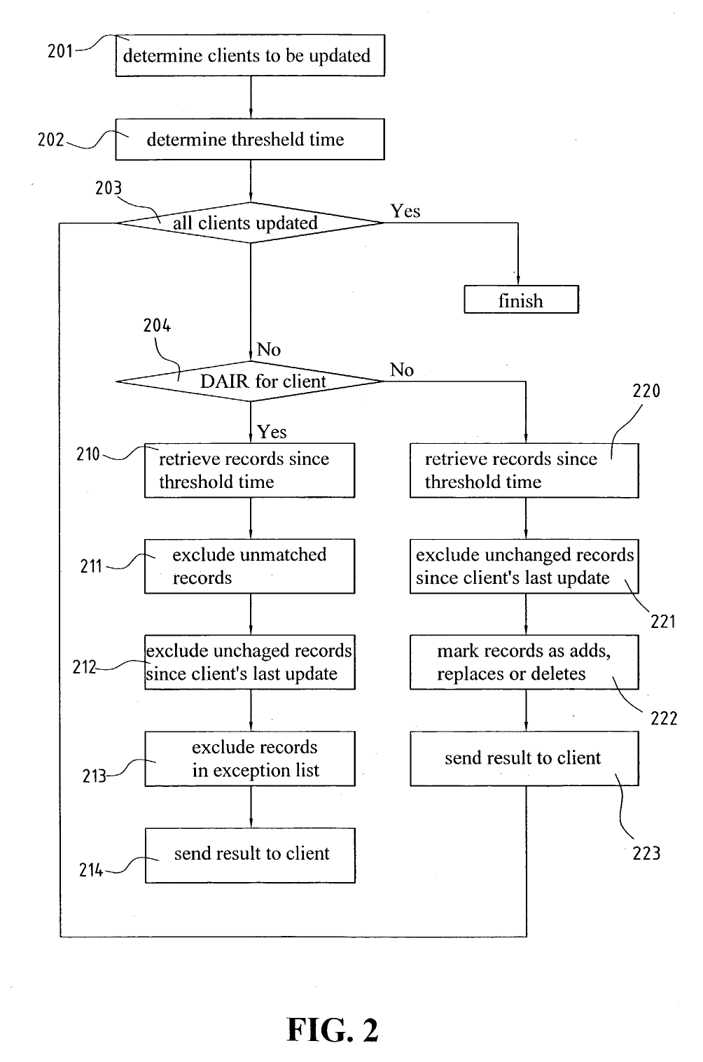

On the other hand, every time the data on the server changes, the server sends its updates to the client. When the data on the server are changed, the server will follow the process shown in FIG. 2 to send updates to the client. In step 201, the server needs o determine which clients are to be updated by consulting the DAIR table, and determine a threshold time after which the changes are to be updated, as shown in step 202. The server updates one client at a time, as shown in step 203, until all of them are updated. If there is a DAIR table entry for the client (step 204), the server takes step 210, i.e., retrieves records later than the threshold time, then excludes those records that are unmatched records (step 211), unchanged since the client's last update (step 212), and those in the exception list (step 213). The results are sent to the client (step 214). This will repeat until all clients are updated (step 203). On the other hand, when there is no corresponding entry for the client, the server retrieves the records (step 220), excludes unchanged ones (step 221), and marks the records according to their action types (step 222). The results are then sent to the client, as step 223 indicates. This will repeat until all clients are updated (step 203).

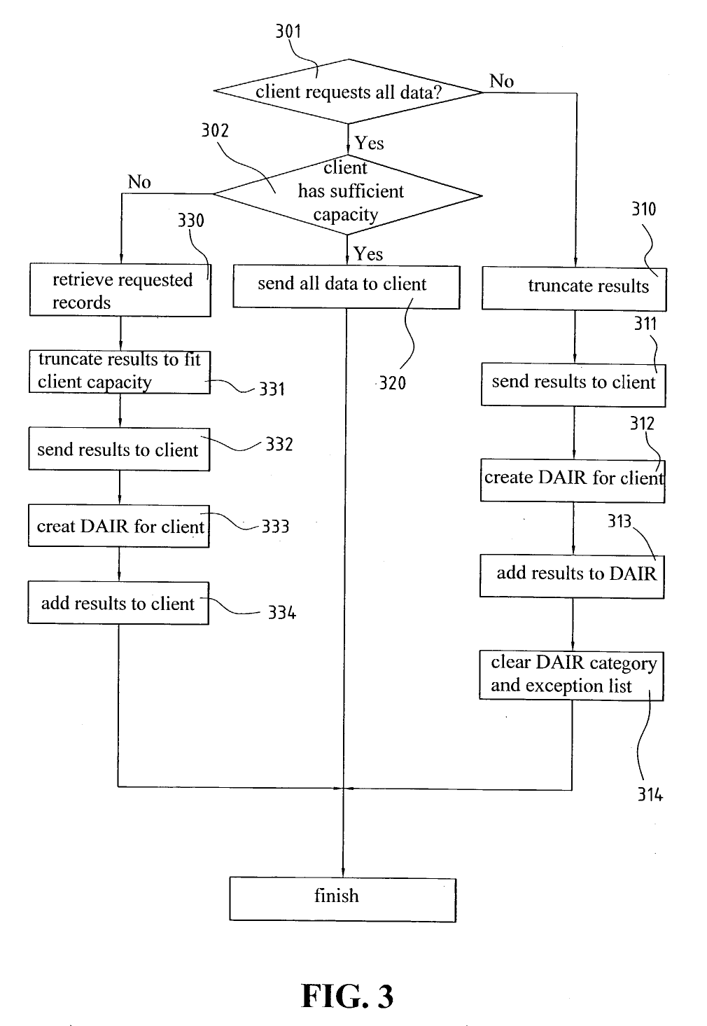

On the other hand, when a server receives requests for data from a client, it follows the process shown in FIG. 3. When a client requests the entire data set (step 301) and it has sufficient capacity to hold the entire data set (step 302), the server sends all the data as requested. Otherwise, if the client does not have sufficient capacity, the server will truncate the result data before sending them to the client (steps 331, 332). A DAIR table entry is also created to indicate that the client holds only a subset of the data, as in steps 333 and 334. Another scenario shows that when a client requests only a partial data set. In this case, the server will only retrieve the requested data, and truncate the results to fit the client's capacity before sending them off (steps 310, 311). Similarly, A DAIR table entry is also created to indicate that the client holds only a subset of the data, as in steps 312, 313 and 314.

Upon receiving updates or requested data from the server, the client will update the local data set. If the client is able to distinguish various record action types, it will perform the addition, deletion, or replacement of the records accordingly. Otherwise, it simply deletes the old data set, and replaces it with the received data.

While we have shown and described the embodiment in accordance with the present invention, it should be clear to those skilled in the art that further embodiments may be made without departing from the scope of the present invention.

What is claimed is:

1. In a wireless data delivery system having a plurality of clients and application servers, a method of minimizing device connection time when performing data synchronization between said clients and said servers, said method comprising:
allowing said client to update records on said server;
allowing said client to request record updates from said server;
allowing said server to update records on said clients; and
allowing said server to send said requested data to said client.

2. A method claimed as in claim 1, wherein said client disconnects from said system immediately after sending data and receiving a result code, in order to minimize connection time while said server performing actual data synchronization after receiving said data.

3. A method claimed as in claim 1, wherein said server connects to said client only immediately before sending said updates or said data, in order to minimize connection time while said server preparing said result data for sending.

4. A method claimed as in claim 1, wherein a device application information record table is maintained by said server to consult during updating. An table entry represents a client, said DAIR table further comprising: a user ID, an application ID, a module ID, a capacity, and the last time said client updates said server and the last time said server update said client.

5. A DAIR table as in claim 3, wherein when said client having only a subset of said server's record set, said DAIR table contains the flowing fields: a list of server record Ids, a number of categories, a category criteria, and an exception list.

6. An apparatus connectable to a wireless data delivery system having a plurality of clients and a plurality, said apparatus comprising:
a first memory storing a device application information record (DAIR) table;
a second memory storing a program; and
a processor responsive to the program to
allow said client to update records on said server,
allow said client to request record update from said server,
allow said server to update records on said clients; and
allow said server to send said requested data to said client.

7. An apparatus claimed as in claim 6, wherein said DAIR table entry further comprising: a user ID, an application ID, a module ID, a capacity, and the last time said client updates said server and the last time said server update said client.

8. A DAIR table as in claim 6, wherein when said client having only a subset of said server's record set, said DAIR table contains the flowing fields: a list of server record Ids, a number of categories, a category criteria, and an exception list.

9. An apparatus claimed as in claim 6, wherein when said apparatus being in operation, said clients can disconnect from said system immediately after sending data and receiving a result code.

10. An apparatus claimed as in claim 6, wherein when said apparatus being in operation, said server only need to connect to said client immediately before sending said updates or said data.
